(19) United States
(12) Patent Application Publication
(10) Pub. No.: US 2022/0392207 A1
(43) Pub. Date: Dec. 8, 2022

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Masami Kato, Kanagawa (JP); Shiori Wakino, Tokyo (JP); Tsewei Chen, Tokyo (JP); Kinya Osa, Tokyo (JP); Motoki Yoshinaga, Kanagawa (JP)

(21) Appl. No.: 17/825,962

(22) Filed: May 26, 2022

(30) Foreign Application Priority Data
May 31, 2021 (JP) 2021-091807

(51) Int. Cl. G06V 10/82; G06V 10/75; G06V 10/77

(52) U.S. Cl. CPC G06V 10/82; G06V 10/751; G06V 10/7715; G06V 10/759; G06V 2201/07

(57) ABSTRACT

An information processing apparatus operable to perform computation processing in a neural network comprises a coefficient storage unit configured to store filter coefficients of the neural network, a feature storage unit configured to store feature data, a storage control unit configured to store in the coefficient storage unit a part of previously obtained feature data as template feature data, a convolution operation unit configured to compute new feature data by a convolution operation between feature data stored in the feature storage unit and filter coefficients stored in the coefficient storage unit, and compute, by a convolution operation between feature data stored in the feature storage unit and the template feature data stored in the coefficient storage unit, correlation data between the feature data stored in the feature storage unit and the template feature data.

### BACKGROUND

### Field of the Disclosure

The present disclosure relates to a computation technique in a neural network having a hierarchical structure.

### Description of the Related Art

A hierarchical computation method (a pattern recognition method based on a deep learning technology) typified by a convolutional neural network (hereinafter abbreviated as CNN) has attracted attention as a pattern recognition method robust against variation in recognition target. For example, Yann LeCun, Koray Kavukvuoglu and Clement Farabet: Convolutional Networks and Applications in Vision, Proc. International Symposium on Circuits and Systems (ISCAS'10), IEEE, 2010, discloses various applications and implementations thereof. As an application of a CNN, an object tracking process using cross-correlation between feature amounts computed by CNN has been proposed (Luca Bertinetto, Jack Valmadre, Joao F. Henriques, Andrea Vedaldi, Philip H. S. Torr: Fully-Convolutional Siamese Networks for Object Tracking, ECCV 2016 Workshops, etc.).

Meanwhile, a dedicated processing apparatus for various neural networks for processing CNNs with high computation costs at high speed (hereinafter abbreviated as “dedicated processing apparatus”) has been proposed (U.S. Pat. No. 9,747,546, Japanese Patent No. 5376920, etc.).

In the object tracking processing method described in the above-mentioned Bertinetto et al. paper, a cross-correlation value between the CNN feature amounts is computed by performing convolution processing by using the CNN feature amounts instead of coefficients of the CNN. Conventionally proposed dedicated processing apparatuses have been proposed for the purpose of efficiently processing convolution operations between CNN coefficients and CNN interlayer data. Therefore, when conventional dedicated processing apparatus is applied to the above-described correlation operation between feature amounts of the CNN, the processing efficiency is lower due to the overhead of setting of data other than the coefficients of the CNN.

### SUMMARY

The present disclosure provides a technique for efficiently performing a convolution operation between feature amounts in a neural network having a hierarchical structure.

According to the first aspect of the present disclosure, there is provided an information processing apparatus operable to perform computation processing in a neural network, the information processing apparatus comprising: a coefficient storage unit configured to store filter coefficients of the neural network; a feature storage unit configured to store feature data; a storage control unit configured to store in the coefficient storage unit a part of previously obtained feature data as template feature data; and a convolution operation unit configured to compute new feature data by a convolution operation between feature data stored in the feature storage unit and filter coefficients stored in the coefficient storage unit, and compute, by a convolution operation between feature data stored in the feature storage unit and the template feature data stored in the coefficient storage unit, correlation data between the feature data stored in the feature storage unit and the template feature data.

According to the second aspect of the present disclosure, there is provided an information processing method that an information processing apparatus operable to perform computation processing in a neural network performs, the method comprising: storing in a coefficient storage unit filter coefficients of the neural network; storing in a feature storage unit feature data; storing in the coefficient storage unit a part of previously obtained feature data as template feature data; and computing new feature data by a convolution operation between feature data stored in the feature storage unit and filter coefficients stored in the coefficient storage unit, and computing, by a convolution operation between feature data stored in the feature storage unit and the template feature data stored in the coefficient storage unit, correlation data between the feature data stored in the feature storage unit and the template feature data.

According to the third aspect of the present disclosure, there is provided a non-transitory computer-readable storage medium storing a computer program for causing a computer comprising a coefficient storage unit configured to store filter coefficients of the neural network and a feature storage unit configured to store feature data to function as a storage control unit configured to store in the coefficient storage unit a part of previously obtained feature data as template feature data; and a convolution operation unit configured to compute new feature data by a convolution operation between feature data stored in the feature storage unit and filter coefficients stored in the coefficient storage unit, and compute, by a convolution operation between feature data stored in the feature storage unit and template feature data stored in the coefficient storage unit, correlation data between the feature data stored in the feature storage unit and the template feature data.

Further features of the present disclosure will become apparent from the following description of exemplary embodiments with reference to the attached drawings.

### BRIEF DESCRIPTION OF THE DRAWINGS

FIG. 1 is a block diagram showing a functional configuration example of a processing unit 201.

FIG. 2 is a block diagram showing an example of the hardware configuration of an information processing apparatus.

FIG. 3 is a block diagram showing a functional configuration example of the processing unit 201.

FIGS. 4A through 4C are diagrams showing various types of processing performed by the information processing apparatus using a CNN.

FIG. 5 is a diagram illustrating a process for generating template features using CNN features.

FIG. 6 is a timing chart showing operation of the information processing apparatus using the processing configuration of FIG. 4.

FIGS. 7A and 7B are diagrams showing a configuration of a setting I/F unit 107 and a configuration of a memory region in a buffer 103.

FIG. 8 is a diagram illustrating an example of a memory configuration of a RAM 205 for storing parameters.

FIG. 9 is a flowchart illustrating operation of a CPU 203.

FIGS. 10A and 10B are diagrams illustrating a format conversion of CNN coefficients and template features.

FIG. 11 is a flowchart illustrating operation of the processing unit 201.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

In the present embodiment, an information processing apparatus that performs computation processing in a neural network having a hierarchical structure will be described. The information processing apparatus according to the present embodiment, in a holding unit, stores, as template features, a part of the feature map obtained based on a convolution operation using filter coefficients of a neural network held in the holding unit. The information processing apparatus performs a convolution operation using the filter coefficients held in the holding unit and a convolution operation using the template features held in the holding unit. In the present embodiment, a case where a CNN is used as the neural network will be described.

The present embodiment will describe a case in which such an information processing apparatus detects a specific object from a captured image and performs a process of tracking the detected object (hereinafter, this series of processes is referred to as a recognition process).

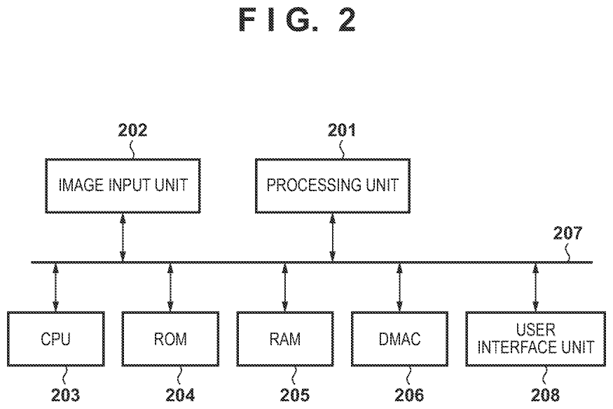

An example of a hardware configuration of the information processing apparatus according to the present embodiment will be described with reference to the block diagram of FIG. 2. A processing unit 201 executes recognition processing (partially) in accordance with an instruction from a CPU 203, and the result of the recognition processing is stored in a RAM 205. The CPU 203 uses the results of the recognition processing stored in the RAM 205 to provide a variety of applications.

An image input unit 202 is an image capturing apparatus for capturing a moving image or an image capturing apparatus for capturing a still image periodically or non-periodically, and includes an optical system, a photoelectric conversion device such as a CCD (Charge-Coupled Device) or CMOS (Complementary Metal Oxide Semiconductor) sensor, and a driver circuit/AD converter for controlling the photoelectric conversion device. The image input unit 202, when capturing a moving image, outputs an image of each frame in the moving image as a captured image. On the other hand, when capturing a still image periodically or non-periodically, the image input unit 202 outputs the still image as a captured image.

The CPU 203 (Central Processing Unit) executes various kinds of processing by executing a computer program or data stored in a ROM (Read Only Memory) 204 or the RAM (Random Access Memory) 205. Thus, the CPU 203 controls the operation of the entire information processing apparatus and executes or controls the respective processing described as being performed by the information processing apparatus.

The ROM 204 stores the setting data of the information processing apparatus, computer programs and data related to activation of the information processing apparatus, computer programs and data related to the basic operation of the information processing apparatus, and the like.

The RAM 205 includes an area for storing computer programs or data loaded from the ROM 204, and an area for storing a captured image acquired from the image input unit 202. The RAM 205 has an area for storing data inputted from the user interface unit 208, and a work area used when the CPU 203 and the processing unit 201 execute various types of processing. In this manner, the RAM 205 can appropriately provide various areas. The RAM 205 can be composed of a large amount of DRAM (Dynamic Access Memory) or the like.

A DMAC (Direct Memory Access Controller) 206 transfers data between devices such as between the processing unit 201 and the image input unit 202, between the processing unit 201 and the RAM 205, and the like.

The user interface unit 208 includes an operation unit that receives an operation input from a user, and a display unit that displays a result of processing in the information processing apparatus as images, text, or the like. For example, the user interface unit 208 is a touch panel screen.

The processing unit 201, the image input unit 202, the CPU 203, the ROM 204, the RAM 205, the DMAC 206, and the user interface unit 208 are all connected to a data bus 207.

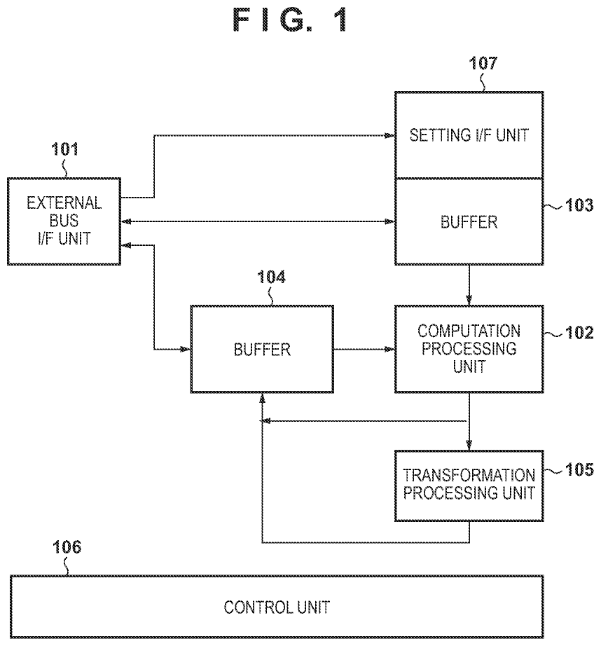

Next, a functional configuration example of the processing unit 201 will be described with reference to a block diagram of FIG. 1. In the present embodiment, it is assumed that each functional unit shown in FIG. 1 is configured by hardware. However, one or more of the other functional units, except for a buffer 103 and a buffer 104, may be implemented in software (computer program). In this instance, the computer program is stored in a memory in the processing unit 201 in the ROM 204, or the like, and the functions of the corresponding functional unit are realized by the control unit 106 or the CPU 203 executing the computer program.

An external bus I/F unit 101 is an interface for the processing unit 201 to perform data communication with the outside, and is an interface that can be accessed by the CPU 203 or the DMAC 206 via the data bus 207.

A computation processing unit 102 performs convolution operation using various data described later. The buffer 103 is a buffer capable of holding CNN filter coefficients (CNN weighting coefficients; hereinafter also referred to as CNN coefficients) and template features. A template feature is a feature amount serving as a template of correlation operation to be described later, and in the present embodiment, a local feature amount in a CNN feature (a feature amount in a partial region in a feature map) is used as a template feature. The buffer 103 supplies the data that it holds to the computation processing unit 102 with a relatively low delay.

The buffer 104 can hold a “feature map for each layer of the CNN (hereinafter, also referred to as CNN features)” obtained by a convolution operation by the computation processing unit 102 or a result of a nonlinear transformation of CNN features by the transformation processing unit 105. The buffer 104 stores, with a relatively low delay, CNN features obtained by the computation processing unit 102 or the result of a nonlinear transformation of CNN features obtained by the transformation processing unit 105.

Incidentally, the buffer 103 or the buffer 104, for example, can be configured using a memory, a register or the like that reads/writes information at high speed. A transformation processing unit 105 non-linearly transforms CNN features obtained by a convolution operation by the computation processing unit 102. A setting I/F unit 107 is an interface that the CPU 203 operates to store template features in the buffer 103. The control unit 106 controls operation of the processing unit 201.

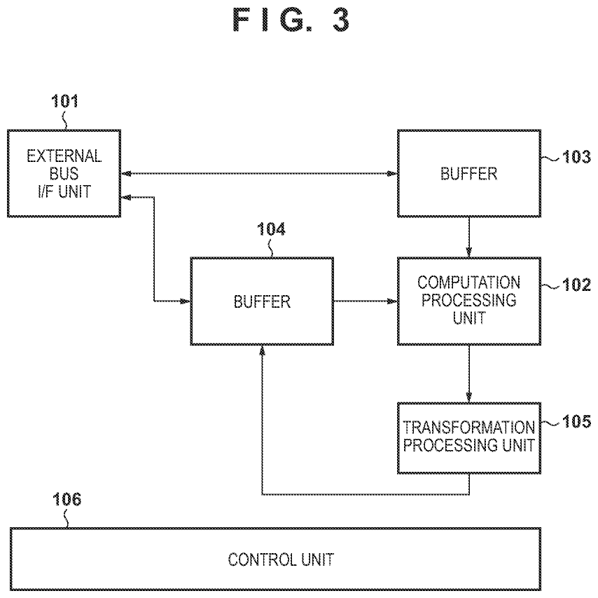

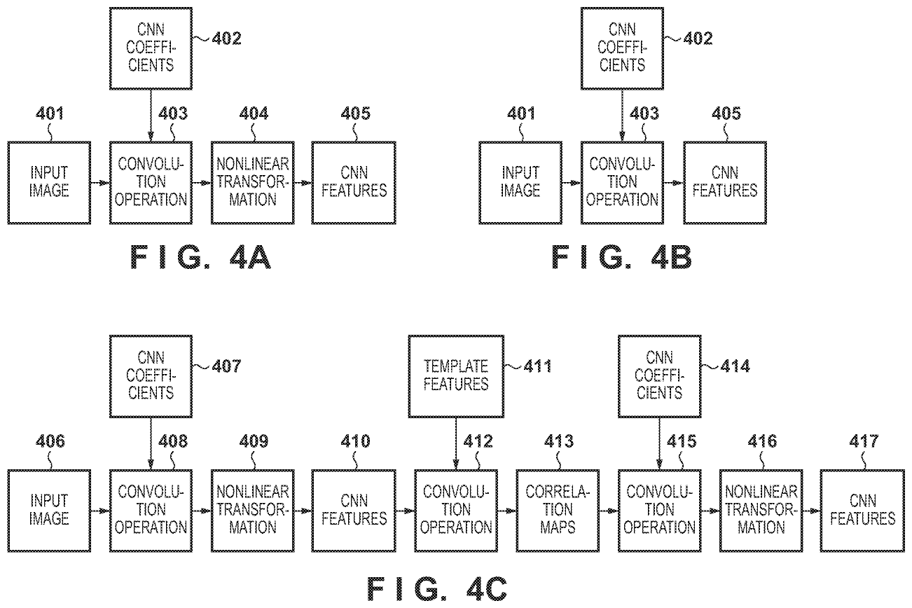

Next, various types of processing performed by the information processing apparatus according to the present embodiment using a CNN will be described with reference to FIGS. 4A through 4C. FIG. 4A is a diagram showing a configuration of processing performed by the information processing apparatus according to the present embodiment to acquire “CNN features serving as a generation source (extraction source) of template features” using CNN.

The computation processing unit 102 performs a convolution operation 403 of an input image 401 that is a captured image acquired from an image input unit 201 via the external bus I/F unit 101 and CNN coefficients 402 that are supplied from the buffer 103.

Here, it is assumed that the size of a kernel (a filter-coefficient matrix) of the convolution operation is columnSize×rowSize, and the number of feature maps in a layer (previous layer) preceding a layer (current layer) to be computed is L. The computation processing unit 102 computes one CNN feature in the current layer by performing an operation according to the following Equation (1).

$$output ( x , y ) = {\sum }_{l = 1}^{L} {\sum }_{row = - rowSize / 2}^{rowSize / 2} {\sum }_{column = - columnSize / 2}^{columnSize / 2} input ( x + column , y + row ) \times weight ( column , row ) \qquad ( 1 )$$

input (x,y): a reference pixel value at coordinates (x, y) in an input image 401
output (x,y): an operation result at coordinates (x, y)
weight (column, row): a coefficient at coordinates (x+column, y+row)
L: the number of feature maps in the previous layer
columnSize: a horizontal size of a two-dimensional convolution kernel
rowSize: a vertical size of a two-dimensional convolution kernel

In general, in computation processing in the CNN, a plurality of convolution kernels are scanned in units of pixels of an input image in accordance with Equation (1), and a product-sum operation is repeated, and the final product-sum operation result is subjected to a nonlinear transformation (activation processing) to compute a feature map. The computation processing unit 102 has a multiplier and a cumulative adder, and executes convolution processing of Equation (1) by the multiplier and cumulative adder.

Next, the transformation processing unit 105 generates CNN features 405 that are a feature map by performing a nonlinear transformation 404 of the results of the convolution operation 403 performed by the computation processing unit 102. In a normal CNN, the above processing is repeated for the number of feature maps to be generated. The transformation processing unit 105 stores the generated CNN features 405 in the buffer 104.

A non-linear function such as ReLU (Rectified Linear Unit) is used as the non-linear function for the nonlinear transformation, but when ReLU is used, all negative numbers become 0, and when it is used for a correlation operation, an amount of data is lost. Especially, the effect is large when the computation is processed by integerization on low-order bits.

Next, a processing configuration in which nonlinear transformation of CNN features is omitted in the processing configuration of FIG. 4A will be described with reference to FIG. 4B. In this processing configuration, the result obtained by the convolution operation 403 by the computation processing unit 102 is directly stored in the buffer 104 as the CNN features 405. This processing configuration can be realized by a method in which a mechanism for bypassing the nonlinear transformation is provided in the transformation processing unit 105, or a method in which a data path for directly storing the result of the convolution operation performed by the computation processing unit 102 in the buffer 104 is provided. The CNN features 405 in this case become signed feature amounts, and all the obtained information can be used.

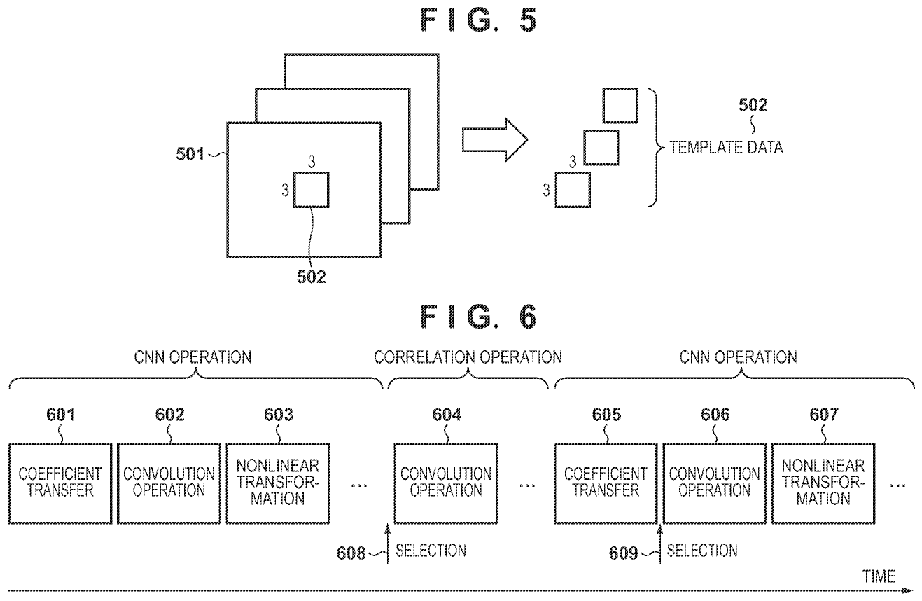

Next, a process for generating template features using CNN features stored in the buffer 104 in the processing configuration of the FIG. 4A or the processing configuration of the FIG. 4B will be described with reference to the example of FIG. 5.

FIG. 5 shows three CNN features 501 stored in the buffer 104 in the processing configuration of FIG. 4A or the processing configuration of FIG. 4B. The CPU 203 extracts, from the CNN features 501 stored in the buffer 104, feature amounts in a region (in the example of FIG. 5, a region having a size of 3×3) at a position designated in advance as the position of an object (in the case of the recognition process, a tracking target) as the template features 502. By using correlation data (correlation maps) between the template features and the CNN features of the detection target, the position of the object can be known. The CPU 203 then converts the format of the template features extracted from the CNN features into a format suitable for storage in the buffer 103, and stores the transformed template features in the buffer 103.

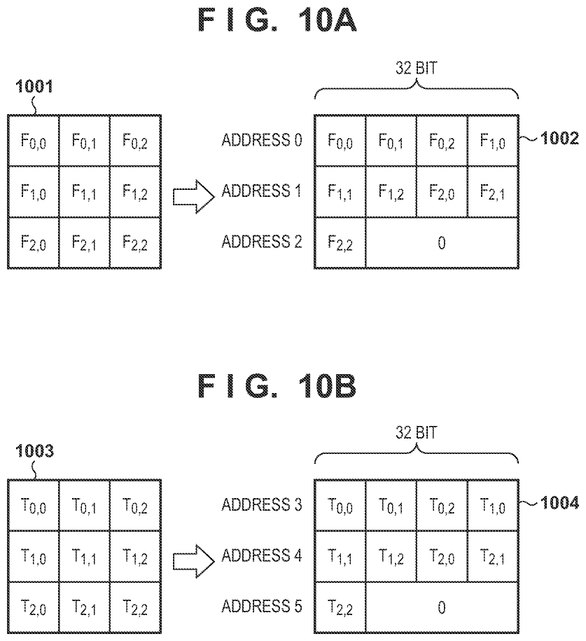

Here, a format conversion when CNN coefficients and template features are stored in the buffer 103 will be described by using the examples of FIGS. 10A and 10B. As shown in FIG. 10A, the CNN coefficients 1001 are CNN coefficients with a filter kernel size of 3×3 and include nine CNN coefficients (F0,0 to F2,2). Each of F0,0 to F2,2 is a CNN coefficient represented by signed 8-bit data.

When storing such CNN coefficients 1001 in the buffer 103, if the data width of the buffer 103 is 32 bits, up to 4 (=32 bits/8 bits) CNN coefficients can be stored at one address. Therefore, the CNN coefficients 1001 are transformed into the CNN coefficients 1002 of a format for storage in the buffer 103, which is a memory having a data width of 32 bits, and the CNN coefficients 1002 are stored in the buffer 103.

The uppermost CNN coefficient sequence (F0,0, F0,1, F0,2, F1,0) in the CNN coefficients 1002 is the CNN coefficient sequence 0 stored at the address 0 in the buffer 103, and the first four CNN coefficients (F0,0, F0,1, F0,2, F1,0) when the nine CNN coefficients in the CNN coefficients 1001 are referenced from the upper left corner in raster scan order are packed therein.

The middle CNN coefficient sequence (F1,1, F1,2, F2,0, F2,1) in the CNN coefficients 1002 is the CNN coefficient sequence 1 stored at the address 1 in the buffer 103, and the next four CNN coefficients (F1,1, F1,2, F2,0, F2,1) in the CNN coefficients 1001 are packed therein.

The lowermost CNN coefficient sequence (F2,2, 0) in the CNN coefficients 1002 is the CNN coefficient sequence 2 to be stored at the address in the buffer 103, and the last one CNN coefficient (F2,2) in the CNN coefficients 1001 and 24 (=32 bits−8 bits) 0s (examples of a dummy value) are packed therein.

The CNN coefficient sequence 0 in CNN features 1002 is then stored at address 0, the CNN coefficient sequence 1 in CNN features 1002 is stored at address 1, and the CNN coefficient sequence 2 in the CNN features 1002 is stored at address 2 in the buffer 103.

A CNN operation consists of many filter kernels, but here an example of storing a single filter kernel is shown. The computation processing unit 102 refers to the CNN coefficients 1002 stored in the buffer 103 in order to efficiently process them.

As shown in FIG. 10B, the template features 1003 include nine feature amounts (T0,0 to T2,2). Each of T0,0 to T2,2 is a feature amount represented by 8 bits.

Here, since the buffer 103 is a memory having a data width of 32 bits, a maximum of 4 (=32 bits/8 bits) feature amounts can be stored at one address. Thus, the CPU 203 transforms the template features 1003 into template features 1004 of a format for storage in the buffer 103, which is a 32-bit data width memory, and stores the template features 1004 in the buffer 103.

In the template features 1004, the uppermost feature amounts (T0,0, T0,1, T0,2, T1,0) are a feature amount sequence 3 stored in the address 3 in the buffer 103, and the first four feature amounts (T0,0, T0,1, T0,2, T1,0) when the nine feature amounts in the template features 1003 are referenced in raster scan order from the upper left corner are packed therein.

In the template feature 1004, the middle feature amount sequence (T1,1, T1,2, T2,0, T2,1) is a feature amount sequence 4 stored in the address 4 in the buffer 103, and the next four feature amounts (T1,1, T1,2, T2,0, T2,1) in the template features 1003 are packed therein.

The lowermost feature amount sequence (T2,2, 0) in the template features 1004 is the feature amount sequence 5 stored in the address 5 in the buffer 103, and the last one feature amount (T2, 2) in the template feature 1003 and 24 (=32 bits−8 bits) 0 (an example of a dummy value) are packed therein.

The CPU 203 stores the feature amount sequence 3 at the address 3 of the buffer 103, stores the feature amount sequence 4 at the address 4 of the buffer 103, and stores the feature amount sequence 5 to the address 5 of the buffer 103, and thereby stores the template features 1004 in the buffer 103.

Thus, both CNN coefficients and template features are stored in the buffer 103 in the same format. Accordingly, the computation processing unit 102 can perform a correlation operation with reference to the template features stored in the buffer 103 without any special overhead, similarly to an operation in a normal CNN.

When the correlation operation is performed by a known information processing apparatus, extracted template features are used as filter coefficients, and parameters for controlling the operation of the information processing apparatus need to be created and stored in the RAM 205 every time the template features are generated. The parameters are a data set including an instruction designating an operation of the processing unit 201 and CNN filter coefficients. Generally, parameters are created offline by an external computer, and the processing cost is high when they are created by the CPU 203 which is built-into the apparatus. Further, when the correlation operation is performed over a plurality of captured images, the template features need to be transferred each time from the RAM 205 which has a large latency. On the other hand, in the present embodiment, it is only necessary to store the filter coefficients in the buffer 103 in alignment with the coefficient storage format. Further, template features stored in the buffer 104 can also be reused when processing over a plurality of captured images.

FIG. 4C is a diagram showing a processing configuration of a recognition process including the above-described correlation operation. The computation processing unit 102 performs a convolution operation 408 of an input image 406 that is a captured image acquired from the image input unit 201 via the external bus I/F unit 101 and CNN coefficients 407 that are supplied from the buffer 103. Next, the transformation processing unit 105 generates CNN features 410 by performing a nonlinear transformation 409 of the result of the convolution operation 408 performed by the computation processing unit 102. That is, CNN features 410 are obtained by repeating the convolution operation 408 and the nonlinear transformation 409 with reference to the CNN coefficients 407 in units of pixels for the input image 406.

The computation processing unit 102 performs a convolution operation 412 between the CNN features 410 and the template features 411 stored in the buffer 103 to compute (correlation operation) a correlation between the CNN features 410 and the template features 411, thereby generating correlation maps 413. In the case of FIG. 5, the CNN features are obtained as three feature maps, and the template features correspond to three 3×3 size filter coefficients. Therefore, in such a case, the convolution operation 412 is repeated in the feature map to compute three correlation maps 413. The correlation operation here has the same operation as so-called depth-wise CNN processing in which the coupling of the output map to the input feature map is one-to-one.

Next, the computation processing unit 102 performs a convolution operation 415 of the correlation maps 413 and the CNN coefficients 414 supplied from the buffer 103. Next, the transformation processing unit 105 generates CNN features 417 by performing a nonlinear transformation 416 of the result of the convolution operation 415 performed by the computation processing unit 102. By performing CNN processing (convolution operation 415 and nonlinear transformation 416) on the correlation maps 413, the object can be robustly detected from the correlation values in the correlation maps.

Then, by performing the processing of FIG. 4C for each captured image supplied from the image input unit 201, it is possible to detect a target object corresponding to the template features for each captured image. That is, it is possible to track a specific target object.

Next, the operation of the information processing apparatus using the processing configuration of FIGS. 4A through 4C will be described with reference to the timing chart of FIG. 6. In the timing chart of FIG. 6, it is assumed that time has elapsed from left to right.

First, in a coefficient transfer 601, the DMAC 206 transfers, by DMA, the CNN coefficients 407, which are a part of the CNN coefficients held in the RAM 205, to the buffer 103. Next, in a convolution operation 602, the computation processing unit 102 performs convolution operation using the input image 406 acquired from the image input unit 201 and the CNN coefficients 407 DMA-transferred to the buffer 103. Next, in a nonlinear transformation 603, the transformation processing unit 105 non-linearly transforms the result of the convolution operation obtained by the convolution operation 602. The CNN features 410 are obtained by repeatedly performing a series of processes (CNN operations) of the coefficient transfer 601, the convolution operation 602, and the nonlinear transformation 603 in accordance with the input image and the number of CNN feature planes to be generated.

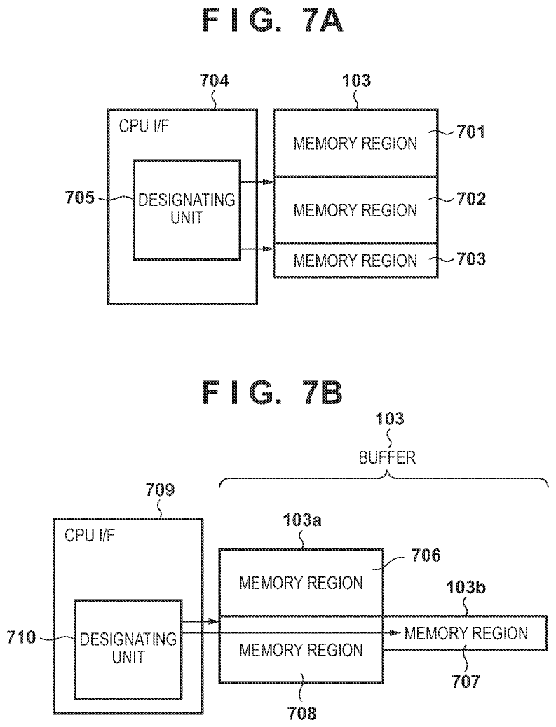

Next, in the convolution operation 604, the computation processing unit 102 performs a convolution operation of the obtained CNN features 410 and the template features 411 stored in the buffer 103, thereby computing (correlation operation) the correlation between the CNN features 410 and the template features 411. The configuration of the setting I/F unit 107 and memory region configuration of the buffer 103 will be described with reference to FIG. 7A.

The buffer 103 includes a memory region 701 for storing the CNN coefficients 407, a memory region 702 for storing the CNN features 414, and a memory region 703 for storing the template features 411 regardless of the hierarchical processing structure of the CNN.

The setting I/F unit 107 includes a CPU I/F 704. The CPU I/F 704 is an interface through which the CPU 203 can directly access the buffer 103 via the external bus I/F unit 101. Specifically, the CPU I/F 704 has a selector mechanism for using a data bus, address bus, control signals, and the like of the buffer 103 mutually exclusively to the computation processing unit 102. This selector mechanism allows the CPU 203 to store template features in the memory region 703 via the CPU I/F 704 if access from the CPU 203 is selected.

The CPU I/F 704 includes a designating unit 705. The designating unit 705 designates a memory region 703 set by the control unit 106 as a memory region for storing template features. For example, the control unit 106 sets the memory region 703 in the selection 608 in accordance with information such as the above-mentioned parameters.

In the convolution operation 604, the correlation between the template features 411 and the CNN features 410 is computed by performing a convolution operation between the CNN features 410 and the template features 411 stored in the memory region 703 set by the control unit 106 in the selection 608. The convolution operation 604 is repeatedly performed in accordance with the feature plane size and the number of feature planes.

Next, in a coefficient transfer 605, the DMAC 206 transfers, by DMA, the CNN coefficients 414, which are a part of the CNN coefficients held in the RAM 205, to the memory region 702 of the buffer 103.

Next, in the selection 609, the control unit 106 sets the memory region referenced by the computation processing unit 102 in the memory region 702. The computation processing unit 102 in the convolution operation 606 performs a convolution operation of the CNN coefficients 414 stored in the set memory region 702 and the correlation maps 413. Then, the transformation processing unit 105 in the nonlinear transformation 607 non-linearly transforms the result of the convolution operation 606. These processes are repeated according to the size and number of correlation maps 413 and the number of output feature planes. The CPU 203 determines a position of a high correlation value (tracking target position) from the obtained CNN features.

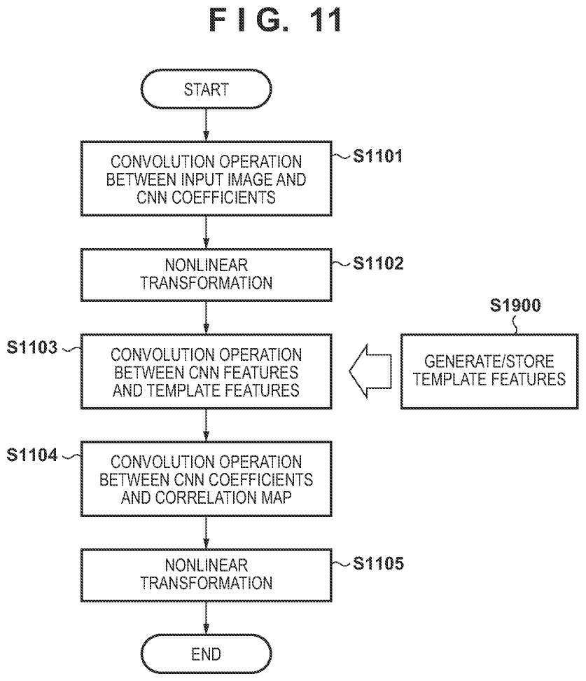

Next, the operation of the above processing unit 201 will be described in accordance with the flowchart of FIG. 11. In step S1101, the computation processing unit 102 performs a convolution operation using a captured image acquired from the image input unit 201 and the CNN coefficients that were DMA-transferred to the buffer 103. Next, in step S1102, the transformation processing unit 105 non-linearly transforms the convolution operation result obtained by the convolution operation in step S1101.

As described above, CNN features are acquired by repeatedly performing a series of processes (CNN operations) of DMA-transfer of CNN coefficients to the buffer 103, processing of step S1101, and processing of step S1102 in accordance with the number of captured images and CNN feature planes to be generated.

In step S1900, which is performed by the CPU 203 before the process of step S1103 starts, the template features are generated as described above, and the generated template features are stored in a memory region set by the control unit 106 in the buffer 103.

Next, in step S1103, the computation processing unit 102 performs convolution operation of the obtained CNN features and the template features stored in the memory region set by the control unit 106 in the buffer 103, thereby computing correlation between the CNN features and the template features. As described above, this convolution operation is repeatedly performed in accordance with the feature plane size and the number of feature planes.

In step S1104, the computation processing unit 102 performs a convolution operation of the CNN coefficients stored in the memory region set by the control unit 106 in the buffer 103 and the correlation maps obtained by the above-described correlation operation. Then, in step S1105, the transformation processing unit 105 non-linearly transforms the convolution operation result obtained by the convolution operation in the step S1104. As described above, these processes are repeated according to the size and number of correlation maps and the number of output feature planes.

As described above, in the present embodiment, the CPU 203 can directly store the template features in the buffer 103, and in the correlation operation, the control unit 106 or the CPU 203 can perform the correlation operation on the template features simply by designating a reference region of the buffer.

When the correlation operation is repeatedly performed on a plurality of captured images, a repetitive process can be repeatedly performed in a state where the template features are held in the memory region 703 in the buffer 103. Therefore, it is not necessary to reset the template features for each captured image.

### <Variation>

The configuration of the setting I/F unit 107 and memory region configuration of the buffer 103 of a variation will be described with reference to FIG. 7B. In the first embodiment, the buffer 103 is a single memory apparatus that holds CNN coefficients and template features, but in the present variation, the buffer 103 is configured by a memory apparatus that holds CNN coefficients and a memory apparatus that holds template features.

The buffer 103 includes a memory apparatus 103a and a memory apparatus 103b. The memory apparatus 103a has a memory region 706 for storing the CNN coefficients 407 and a memory region 708 for storing the CNN features 414. The memory apparatus 103b includes a memory region 707 for storing template features 411 regardless of the hierarchical processing structure of the CNN.

The setting I/F unit 107 includes a CPU I/F 709. The CPU I/F 709, similarly to the CPU I/F 704, is an interface through which the CPU 203 can directly access the buffer 103 via the external bus I/F unit 101.

The CPU I/F 709 includes a designating unit 710. The designating unit 710, similarly to the designating unit 705, designates a memory region 707 set by the control unit 106 as a memory region for storing template features. The control unit 106 sets one of the memory regions 706 and 708 in the memory apparatus 103a when the CNN operation is performed, and sets the memory region 707 in the memory apparatus 103b when the correlation operation is performed.

With such a configuration, for example, the CPU 203 can rewrite the template features stored in the memory apparatus 103b (memory region 707) during the operation of the CNN operation (i.e., while the computation processing unit 102 accesses the memory apparatus 103a). This can reduce the overhead of setting template features.

In FIG. 7B, an example in which the memory apparatus is switched at the same address on the memory map has been described, but different memory apparatuses may be arranged at different addresses as in the example of FIG. 7A.

As described above, according to the present embodiment, since the template features are stored in the same format as the CNN coefficients in the memory holding the CNN coefficients, the CNN operation and the correlation operation can be processed by apparatuses with the same configuration. In addition, a correlation operation can be performed on a plurality of captured images in a state where template features are held.

### Second Embodiment

In the present embodiment, differences from the first embodiment will be described, and unless specifically mentioned below, it should be assumed to be the same as the first embodiment. A functional configuration example of the processing unit 201 according to the present embodiment will be described with reference to a block diagram of FIG. 3. In the present embodiment, each functional unit shown in FIG. 3 is described as being configured by hardware. However, one or more of the other functional units, except for the buffer 103 and the buffer 104, may be implemented in software (computer program). In this instance, the computer program is stored in a memory in the processing unit 201 in the ROM 204, or the like, and the functions of the corresponding functional unit are realized by the control unit 106 or the CPU 203 executing the computer program. The configuration shown in FIG. 3 is a configuration in which the setting I/F unit 107 is deleted from the configuration shown in FIG. 1.

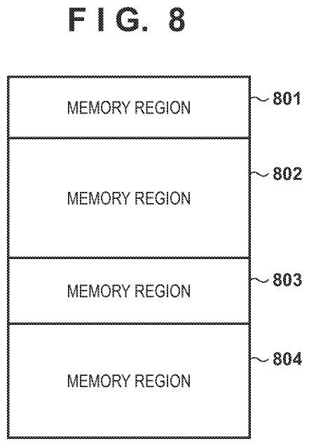

First, a memory configuration example of the RAM 205 for storing parameters for realizing the processing configuration of FIG. 4B will be described with reference to FIG. 8. A memory region 801 is a memory region for storing control parameters for determining the operation of the control unit 106 in the processing unit 201. The memory region 802 is a memory region for storing the CNN coefficients 407. The memory region 803 is a memory region for storing the template features 411. The memory region 804 is a memory region for storing the CNN coefficients 414. The control parameters stored in the memory region 801, the CNN coefficients 407 stored in the memory region 802, the template features 411 stored in the memory region 803, and the CNN coefficients 414 stored in the memory region 804 are parameters for realizing the processing configuration of the FIG. 4B.

Prior to the operation of the processing unit 201, the CPU 203 stores the control parameters in the memory region 801, and stores the CNN coefficients 407 in the memory region 802. Further, the CPU 203 secures the memory region 803 as a memory region for storing the template features 411 and secures the memory region 804 as a memory region for storing the CNN coefficients 414. The memory region 803 is secured according to the number of input feature maps and output feature maps and the size of the filter kernel for which the template features 411 are regarded as filter coefficients in a CNN operation. When the template features 411 are generated, the CPU 203 stores the template features 411 in the memory region 803. When updating the template features, the CPU 203 accesses the memory region 803 and overwrites the template features stored in the memory region 803 with the new template features. When the CNN coefficients 414 are generated, the CPU 203 stores the CNN coefficients 414 in the memory region 804.

The DMAC 206 controls data transfer between the memory regions 801 to 804 and the CPU 203 and data transfer between the memory regions 801 to 804 and the processing unit 201. As a result, the DMAC 206 transfers necessary data (data necessary for the CPU 203 and the processing unit 201 to perform processing) from the memory regions 801 to 804 to the CPU 203 and the processing unit 201. In addition, the DMAC 206 transfers data outputted from the CPU 203 and the processing unit 201 to a corresponding one of the memory regions 801 to 804. For example, when the processing of the processing configuration shown in FIG. 4B is executed for each captured image sequentially inputted, the data stored in the memory regions 801 to 804 is reused.

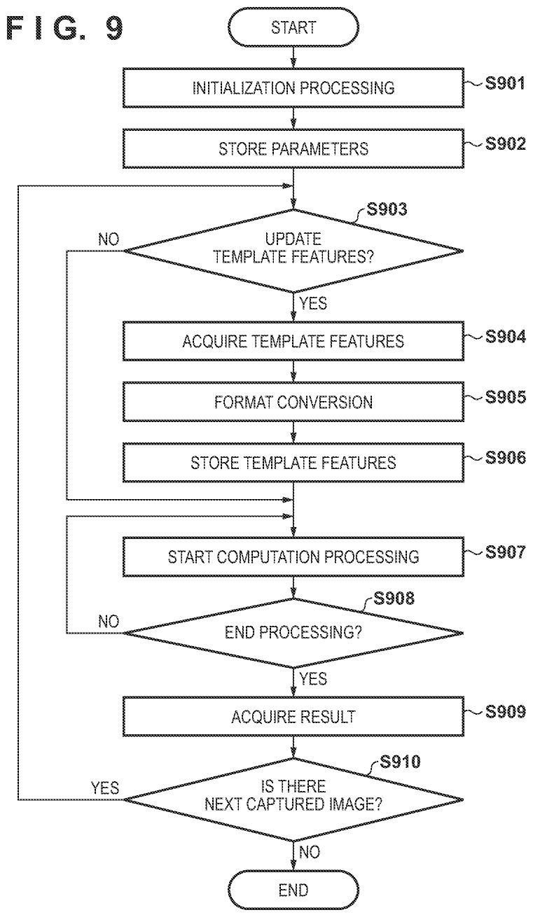

Next, the operation of the CPU 203 according to the present embodiment will be described in accordance with the flowchart of FIG. 9. In step S901, the CPU 203 executes initialization processing of the processing unit 201. The initialization processing includes a process of allocating the above-described memory regions 801 to 804 in the RAM 205.

In step S902, the CPU 203 prepares control parameters required for the operation of the processing unit 201, and stores the prepared control parameters in the memory region 801 of the RAM 205. The control parameters may be created in advance by an external apparatus, and control parameters that are stored in the ROM 204 may be copied and used.

In step S903, the CPU 203 determines the presence or absence of an update of template features. For example, when the processing unit 201 performs processing on an image of a first frame in a moving image or performs processing on a first still image in periodic or non-periodic capturing, the CPU 203 determines that the template features are to be updated. Further, for example, the CPU 203 determines that, when the user operates the user interface unit 208 to input an instruction to update the template features, the template features are to be updated.

As a result of such a determination, when it is determined that the template features are to be updated, the process proceeds to step S904, and when it is not determined that the template features are to be updated, the process proceeds to step S907.

In step S904, the CPU 203 obtains the template features as described above. In step S905, the CPU 203 transforms the format of the template features acquired in step S904 into a format suitable for storage in the buffer 103 (the order in which the computation processing unit 102 reference is possible without overhead, that is, the same storage format as the CNN coefficients (coefficient storage format)). In step S906, the CPU 203 stores the format-transformed template features in the memory region 803 in the RAM 205 in step S905.

In step S907, the CPU 203 controls the DMAC 206 to transfer the control parameters stored in the memory region 801, the CNN features stored in the memory region 802 and the memory region 804, the template features stored in the memory region 803, and the like to the processing unit 201, and then instructs the processing unit 201 to start computation processing. The processing unit 201, by this instruction, operates as described above for the captured image acquired from the image input unit 201, for example, and performs processing of the processing configuration shown in FIG. 4C for the captured image.

In step S908, the CPU 203 determines whether or not the termination condition of the process is satisfied. The condition for ending the processing is not limited to a specific condition. Processing end conditions include, for example, “the processing by the processing unit 201 has been completed for a preset number of captured images input from the image input unit 201”, and “the user has input an instruction to end the processing by operating the user interface unit 208”.

As a result of such determination, when a processing end condition is satisfied, the process proceeds to step S909, and when the processing end conditions are not satisfied, the process proceeds to step S907.

In step S909, the CPU 203 acquires the processing result of the processing unit 201 (for example, the result of the recognition processing based on the processing according to the flowchart of FIG. 11), and passes the acquired processing result to the application being executed.

In step S910, the CPU 203 determines whether or not there is a next captured image to be processed. As a result of this determination, when it is determined that there is a next captured image to be processed, the process proceeds to step S903, and when it is determined that there is no next captured image to be processed, the process according to the flowchart of FIG. 9 ends.

As described above, according to the present embodiment, it is possible to process a neural network including a correlation operation while updating the template features simply by rewriting a part of the memory region in the RAM 205 (the memory region 803 in the above-described example).

### <Variation>

In the first embodiment and the second embodiment, cases where the information processing apparatus operates with respect to captured images supplied from the image input unit 201 have been described. However, the information processing apparatus may operate on a captured image captured in advance and stored in a memory apparatus inside the information processing apparatus or outside the information processing apparatus. The information processing apparatus may operate on a captured image held in an external apparatus capable of communicating with the information processing apparatus via a network such as a LAN or the Internet.

The information processing apparatus of the first embodiment and the second embodiment is an image capturing apparatus having an image input unit 201 for capturing an image. However, the image input unit 201 may be an external apparatus of the information processing apparatus, and in this case, a computer apparatus such as a PC (personal computer) or a tablet terminal apparatus to which the image input unit 201 can be connected is applicable to the information processing apparatus.

Further, the first embodiment and the second embodiment described the operation of the information processing apparatus when two-dimensional images acquired by a two-dimensional image sensor are input, but the data that the information processing apparatus targets is not limited to the two-dimensional images. For example, data collected by various sensors such as sensors for collecting data of dimensions other than two dimensions and sensors of different modalities (such as voice data and radio wave sensor data) can also be the processing target of the information processing apparatus.

In the first embodiment and the second embodiment, cases where a CNN is used as a neural network have been described, but other types of neural networks based on convolution operations may be used.

In the first embodiment and the second embodiment, cases where CNN features extracted from a partial region in a feature map are acquired as template features have been described, but the method of acquiring template features is not limited to a specific collection method.

In addition, the numerical values, processing timing, processing order, processing subject, transmission destination/transmission source/storage location of data (information) used in each of the above-described embodiments and variations are given by way of example in order to provide a specific explanation, and there is no intention to limit the disclosure to such an example.

In addition, some or all of the above-described embodiments and variations may be used in combination as appropriate. In addition, some or all of the above-described embodiments and variations may be used selectively.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims is to be accorded the broadest interpretation so as to encompass all such modifications and equivalent structures and functions.

This application claims the benefit of Japanese Patent Application No. 2021-091807, filed May 31, 2021, which is hereby incorporated by reference herein in its entirety.

What is claimed is:

1. An information processing apparatus operable to perform computation processing in a neural network, the information processing apparatus comprising:
a coefficient storage unit configured to store filter coefficients of the neural network;
a feature storage unit configured to store feature data;
a storage control unit configured to store in the coefficient storage unit a part of previously obtained feature data as template feature data; and
a convolution operation unit configured to compute new feature data by a convolution operation between feature data stored in the feature storage unit and filter coefficients stored in the coefficient storage unit, and compute, by a convolution operation between feature data stored in the feature storage unit and the template feature data stored in the coefficient storage unit, correlation data between the feature data stored in the feature storage unit and the template feature data.

2. The information processing apparatus according to claim 1, wherein the storage control unit stores in the coefficient storage unit a part of the feature data computed by the convolution operation unit as the template feature data.

3. The information processing apparatus according to claim 1,
further comprising a transformation unit configured to non-linearly transform feature data computed by the convolution operation unit,
wherein the storage control unit stores in the coefficient storage unit a part of the feature data non-linearly transformed by the transformation unit as the template feature data.

4. The information processing apparatus according to claim 1, wherein the storage control unit is configured to convert the template feature data into the same format as the filter coefficients and store the converted template feature data in the coefficient storage unit.

5. The information processing apparatus according to claim 1, wherein the coefficient storage unit is a single memory apparatus comprising a memory region configured to store the filter coefficients and a memory region configured to store the template feature data.

6. The information processing apparatus according to claim 1, wherein the coefficient storage unit comprises a memory apparatus configured to store the filter coefficients and a memory apparatus configured to store the template feature data.

7. The information processing apparatus according to claim 1, wherein
the feature data is a feature map, and
the storage control unit stores in the coefficient storage unit feature amounts in a region of a target object to be a target of tracking in the feature map as the template feature data.

8. The information processing apparatus according to claim 1, wherein
the convolution operation unit comprises
a first convolution operation unit configured to perform a convolution operation using filter coefficients stored in the coefficient storage unit;
a second convolution operation unit configured to perform a convolution operation between a result of a nonlinear transformation on a result of the convolution operation by the first convolution operation unit and the template feature data stored in the coefficient storage unit; and
a third convolution operation unit configured to perform a convolution operation between a result of the convolution operation by the second convolution operation unit and the filter coefficients stored in the coefficient storage unit.

9. The information processing apparatus according to claim 8, further comprising a detection unit configured to detect an object based on a result of a nonlinear transformation which is performed on a result of the convolution operation by the third convolution operation unit.

10. The information processing apparatus according to claim 8, wherein the coefficient storage unit holds filter coefficients that are used by the first convolution operation unit and filter coefficients that are used by the third convolution operation unit.

11. The information processing apparatus according to claim 1, further comprising a unit configured to designate a memory region for storing the template feature data in the coefficient storage unit.

12. The information processing apparatus according to claim 1, wherein the storage control unit determines whether or not to update the template feature data and, in a case where it determines to update the template feature data, transfers new template feature data to the coefficient storage unit.

13. An information processing method that an information processing apparatus operable to perform computation processing in a neural network performs, the method comprising:
storing in a coefficient storage unit filter coefficients of the neural network;
storing in a feature storage unit feature data;
storing in the coefficient storage unit a part of previously obtained feature data as template feature data; and
computing new feature data by a convolution operation between feature data stored in the feature storage unit and filter coefficients stored in the coefficient storage unit, and computing, by a convolution operation between feature data stored in the feature storage unit and the template feature data stored in the coefficient storage unit, correlation data between the feature data stored in the feature storage unit and the template feature data.

14. A non-transitory computer-readable storage medium storing a computer program for causing a computer to execute an information processing method, the method comprising:
storing in a coefficient storage unit filter coefficients of the neural network;
storing in a feature storage unit feature data;
storing in the coefficient storage unit a part of previously obtained feature data as template feature data; and
computing new feature data by a convolution operation between feature data stored in the feature storage unit and filter coefficients stored in the coefficient storage unit, and computing, by a convolution operation between feature data stored in the feature storage unit and the template feature data stored in the coefficient storage unit, correlation data between the feature data stored in the feature storage unit and the template feature data.
